(19) United States
(12) Patent Application Publication
(10) Pub. No.: US 2002/0198681 A1
(43) Pub. Date: Dec. 26, 2002

(54) Flexible efficient branching particle tracking algorithms

(76) Inventors: Michael A. Kouritzin, Edmonton (CA); Klaus E. Fleischmann, Berlin (DE)

Correspondence Address: Lockheed Martin Corporation, NE&SS-Tactical Systems, 3333 Pilot Knob Road, Eagan, MN, 55121, US

(21) Appl. No.: 09/879,210

(22) Filed: Jun. 13, 2001

(51) Int. Cl. G06F 15/00

(52) U.S. Cl. 702/181

(57) ABSTRACT

A particle filter is employed so that particle locations provide signal information to construct an approximated conditional distribution of probabilistic signal state. For an optimal tracking filter, current particles are used with weight value of one for each. To construct an optimal predicting filter, a copy of the current particles are evolved forward to the time for which the prediction is to occur. A new branching particle method allows the construction of optimal smoothing filters. Ancestor particles retain probabilistic data about the likely historical path of the signal. Then these particles, weighted by their associated ancestor particle weights, provide the approximate asymptotically optimal conditional distribution of the signal state at the collection of previous times. The branching particle filter operates recursively on the observation data, allowing real-time operation of the system. It is asymptotically optimal in increasing numbers of particles and in a decreasing period of time between observations, but the rate of convergence with regards to the observation period is extremely fast.

Be it known that we, Michael A. Kouritzin, a citizen of Canada, and Klaus E. Fleischmann, a citizen of Germany, have invented new and useful improvements in the above-mentioned invention, of which the following is a specification.

### BACKGROUND OF THE INVENTION

The present invention relates to a method and a system for efficient non-linear optimal tracking, smoothing, and prediction of dynamic processes in real time

Many industries require a system to determine the location and state of a signal in some domain. For example, one might want to know the position, orientation, and velocity of an aircraft over a busy airport. Additionally, it might be important to know where the aircraft is likely to be in the future and what path it has taken in the past. In many such cases full information about the b signal is not available. Instead, only distorted, corrupted, partial information given by discrete-time observations is provided. In the aircraft example, the only data provided to the airport might be noisy transmissions of truncated altimeter and range data from the aircraft that arrive at two second intervals. While perfect determination of the signal state is impossible under these circumstances, it is still desirable to obtain probabilistic estimates of the state conditioned on the information that is available. Preferably one should also obtain smoothed estimates of past signal states, probabilistic information on the likelihood of various signal paths, and predictions of future states given all observations up to some time.

More precisely stated, the problem is as follows. The signal Xₜ to be tracked is a cadlag Markov process, for example it may follow an Ito equation

dXₜ=A(Xₜ)+B(Xₜ)dBₜ,

or more, generally a Martingale problem on a complete separable metric space. The discrete observations Yₜ_{ₖ}, occurring at times tₖ, are dependent on the signal in a stochastic manner described by

Tₜ_{ₖ}=hₖ(Xₜ_{ₖ},Vₖ),

where Vₖ is a sequence of random variables that model the noise input into this time-varying dependence. These formulae might not be precisely known in a particular instance and some extra randomness can be introduced to model this implementation uncertainty.

The requirement is to construct a device which can efficiently determine the conditional distribution of the state of the signal given all observations up to the current time, that is,

P(Xₜ_{ₖ}εdx|Yₜ_{ᵢ}, i≦k).

This device is known as an optimal tracker. Also, the device should provide smoothers to estimate past signal states and predictors to estimate future signal states, that is,

P(X_{τ}_{ₛ}εdx|Yₜ_{ᵢ}, i≦k)

and

P(X_{τ}_{ₚ}εdx|Yₜ_{ᵢ}, i≦k),

where τₛ<tₖ and τₚ>tₖ. Indeed, one is often interested in

P(X_{[τ}_{ₛ}_{,τ}_{ₚ}_{]}εdz|Yₜ_{ᵢ}, i≦k),

where z ranges over the cadlag functions and X_{[τ}_{ₛ}_{,τ}_{ₚ}_{]} represents the path of the signal between times τₛ and τₚ.

In the specific Ito equation case in which the stochastic dynamics given by A and B are linear, the observation function h is of the form

hₖ(Xₜ_{ₕ}, Vₖ)=\hat{h}ₖ×Xₜ_{ₕ}+Vₖ (additive noise),

and each Vₖ is an independently distributed Gaussian random variable, an efficient recursive optimal tracker is already known: the Kalman filter. Re-cursive, in this context, means that the computation involved with each new observation requires the data of that observation only with no direct reference to the data of any previous observation. This allows the Kalman filter to operate very quickly. However, as noted, the Kalman filter has very stringent requirements on the possible signal dynamics and on the form of the observation noise. As well, it provides no direct method to provide predictors or smoothers.

Despite these shortcomings, the Kalman filter is the core of most current devices to provide filtering solutions. In linear Gaussian additive environments, trackers based on the Kalman filter produce optimal estimates. For more general environments the Kalman filter is suboptimal, but can still provide some solution in the form of the extended Kalman filter. Later developments have included running multiple Kalman filters in banks, each with different assumptions about the signal dynamics, and weighting the Kalman filters and their inputs to provide a track. This method is called the interacting multiple model tracker, and provides improved but still suboptimal tracking.

New techniques have expanded the class of filtering problems that can be solved using exact methods. These techniques provide readily implementable computer algorithms that are nearly as efficient as the Kalman filter and 2 provide optimal solutions. However, the problems that can be solved in this manner still form a small subset of the whole space of real world problems.

A more recent type of general solution to the filtering problem is the set of particle methods. These techniques simulate a large number of independent samples

$${ξ}_{t}^{j}$$

of the signal, called particles. The set of particles

$${ξ}_{t}^{j} ,$$

0≦j≦N are then adjusted in some manner to conform to each observation, possibly by assigning each a scalar weight value

$${W}_{t}^{j}$$

or by interchanging the state values associated with each particle in some manner. The conditional distribution of the state of the signal at the current time is approximated by the locations of the particles and their weights, specifically,

$$P ( {X}_{{t}_{k}} ∈ S \vert {Y}_{{t}_{i}} , i \leq k ) \approx \frac{1}{{\sum }_{j = 1}^{N} {W}_{{t}_{k}}^{j}} {\sum }_{j = 1}^{N} {W}_{{t}_{k}}^{j} {δ}_{{ξ}_{{t}_{k}}^{j}} ( S ) .$$

The particle adjustment is performed in such a manner that the resulting weighted particle distribution converges to the optimal conditional distribution of the signal, given the observations, as the number of particles, N, is, increased. Predicted distributions for some time τₚ>tₖ conditioned on observations up to time tₖ are obtained by simulating the particles forward in time without any adjustment.

Two possible particle methods are described in U.S. Pat. No. 5,933,352 published on Aug. 3, 1999 in the name of Gerard Salut, entitled “Method and a system for non-linear optimal estimation of dynamic processes in real time”. In the first system, the claimed method of adjusting the particles to match the observations is solely to maintain a weight value associated with each particle and to modify this weight in accordance with each observation. This method has two sub-methods, in one of which the influence of past observations on the particle weights is attenuated in time, and in the other of which the influence of past observation on the weights is strictly limited in time.

A second system claimed by U.S. Pat. No. 5,933,352 is to adjust the particles after each observation by redistributing some or all of their state data. This random redistribution is conducted such that particles with a higher weight are more likely to have their state data overwrite the state data of other particles that are part of the redistribution process. In this manner, the particle states are preferentially collected around the areas of the state space which have the highest conditional probability of containing the signal. While U.S. Pat. No. 5,933,352 does not specifically state this, it can be assumed that the intention is for all particles that are involved in this redistribution to have their weights set to the average of the weights of all involved particles after the redistribution is complete, since this is the condition which will retain the asymptotic optimality of the system.

As U.S. Pat. No. 5,933,352 states, simple particle weighting without redistribution causes degeneration in the output conditional distribution that can be rectified only to some degree by attenuating or limiting the effect of older observations. These actions themselves entail an unavoidable loss of asymptotic optimality in increasing numbers of particles for the filter. If only some particles are redistributed, there are still some degenerative effects working against optimality, and the calculation of the average weight for a subset of the particles is cumbersome.

However, a great amount of computation is involved in redistributing all of the particle states at each time step. This effort is especially pronounced if the particle data must travel between processing units in a distributed architecture. Moreover, redistributing all of the particles instead of merely considering each particle to determine whether redistribution or branching (as discussed below) is appropriate for it induces undue extra randomness that impairs path space capabilities and downgrades performance.

Neither of the systems claimed in U.S. Pat. No. 5,933,352 provide smoothing distributions, that is, estimates of the signal state for times τₛ<tₖ, given the observations up to time tₖ. They also provide no estimates of the historical path of the signal.

### BRIEF SUMMARY OF THE INVENTION

The present invention relates to a method and a system for efficient non-linear optimal tracking, smoothing, and prediction of dynamic processes in real time. The method used is to store a large number of independent samples of the signal state, known as particles. The branching particle-based nonlinear filter accepts a sequence of measurements from sensors, each of which contain noisy, corrupted, and distorted information about the position of the signal (i.e. “measurement noise”), adjusts its particles in a novel manner such that they conform to the measurements, and then uses these particles to provide smoothing, tracking, and predicting approximate conditional distributions of the signal state. These distributions can be used to provide a human display interface or to control automated systems.

### BRIEF DESCRIPTION OF THE DRAWINGS

The method of the invention is illustrated by the drawings in which:

FIG. 1 shows the filtering process;

FIG. 2 shows the filter observation process;

FIG. 3 shows the evolve particle process;

FIG. 4 shows the branch particle process;

FIG. 5 shows the renormalize particle count process;

FIG. 6 shows the duplicate particle process, and

FIG. 7 shows the remove particle process.

### DETAILED DESCRIPTION OF THE INVENTION

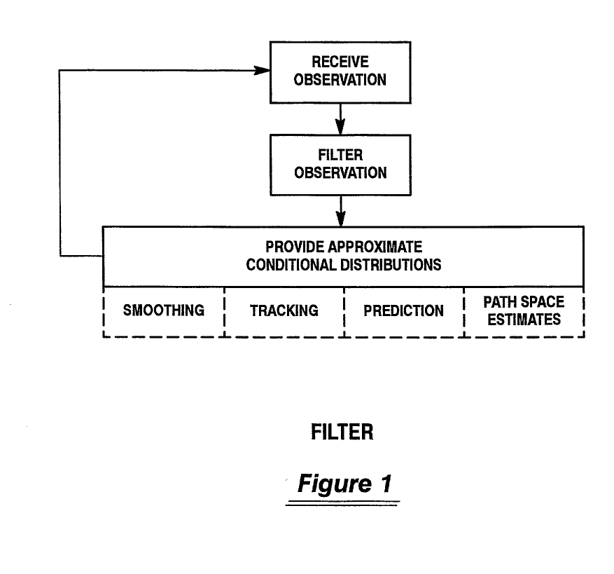

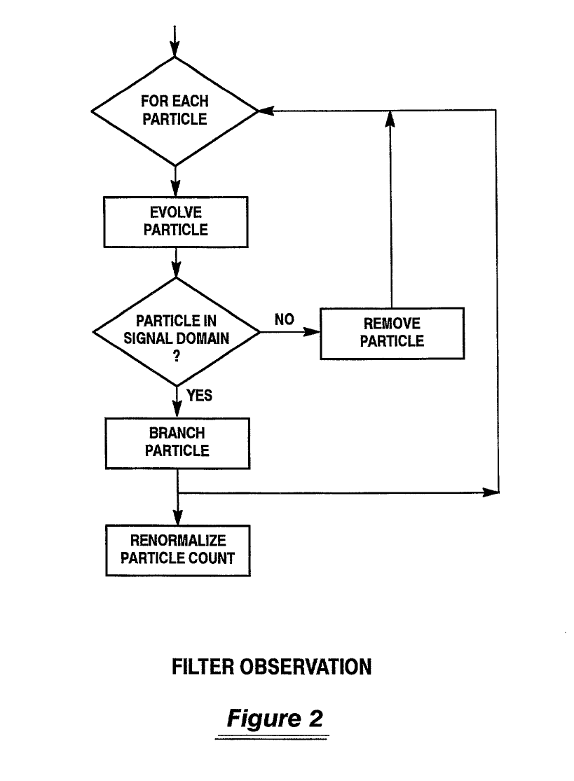

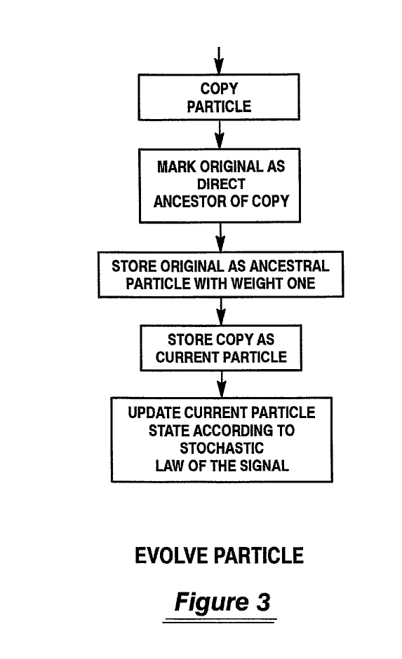

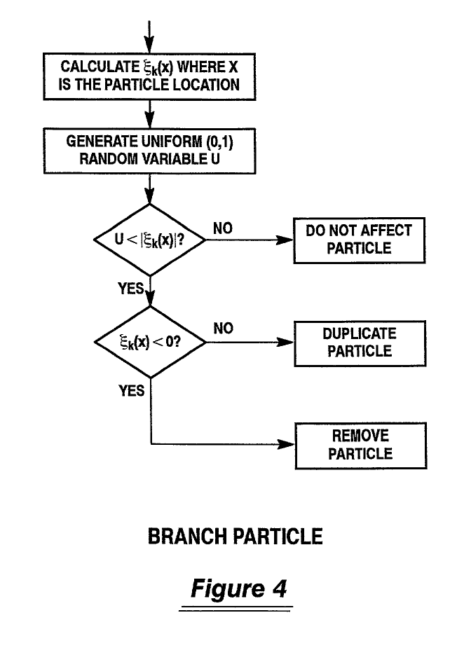

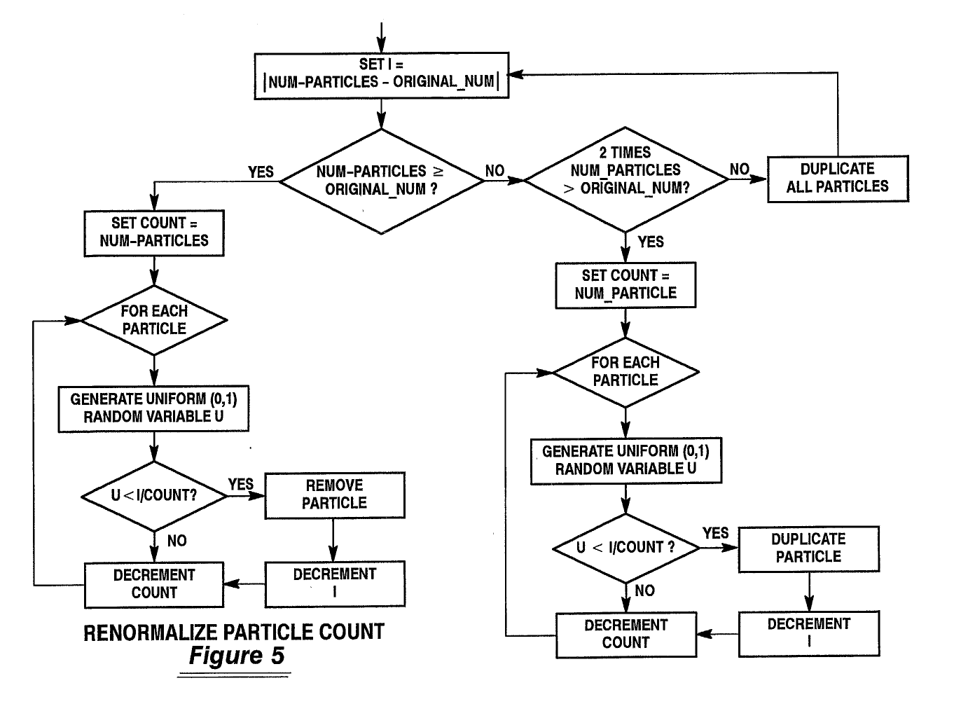

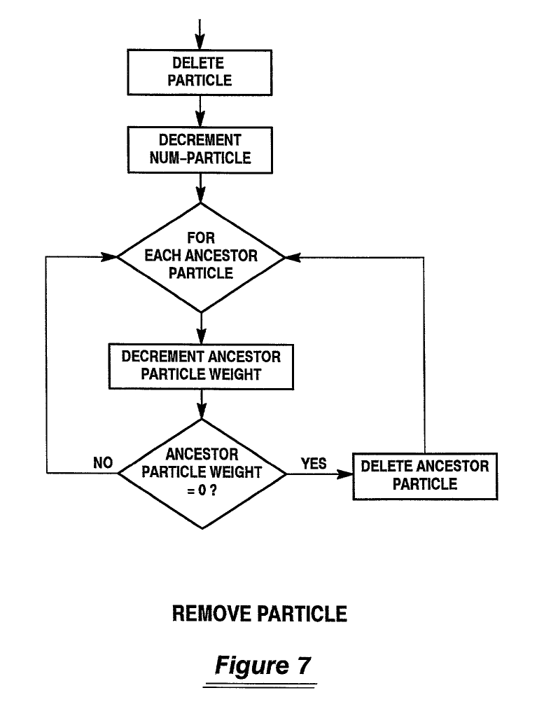

In accordance with the method of the invention, a filter is shown in FIG. 1. In processing each observation (FIG. 2: Filter Observation), the filter first evolves each particle state forward in time (FIG. 3: Evolve Particle) and removes (FIG. 7: Remove Particle) particles that have left the bounds of the signal domain, if the particle evolution allows this. Each particle is then branched (FIG. 4: Branch Particle) according to the observation, and after each particle has been processed, the total particle count is renormalized (FIG. 5: Renormalize Particle Count).

To evolve a particle (FIG. 3: Evolve Particle), the particle state is first copied to a separate logical location in the device, and the original is marked as the direct ancestor of the new particle. A forward evolution of the state of the new particle is then simulated according to the stochastic law of the signal process, or if that is not available then some perturbed approximate model of the signal process. The time period for this forward evolution is given by the length of time between the preceding observation and the observation presently under consideration.

After evolving each particle, the particles are then branched (FIG. 4: Branch Particle) to account for the information from the observation. A value labeled ξₖ(x) is calculated for a given particle x in response to the observation at time tₖ according to the formula

$${ξ}_{k} ( x ) = min \{ \vert {ζ}_{k} ( x ) \vert , 1 \} \cdot sgn \{ {ζ}_{k} ( x ) \} , \\ \text{where}$$

$${ζ}_{k} ( x ) = \frac{{θ}_{k} ( {g}_{k} ( {Y}_{k} , x ) ) {J}_{k} ( {Y}_{k} , x )}{{θ}_{k} ( {Y}_{k} )} - 1.$$

In this formula, Ok is the density function for the random variable Vₖ that models the noise input, the function gₖ(Yₖ, x)=vₖ is the inverse map of the function hₖ(x, Vₖ)=Yₖ that describes the observations, and Jₖ(Yₖ, x) is the determinant of the matrix

$${\{ \frac{\partial {g}_{k}^{i}}{\partial {Y}_{k}^{j}} ( {Y}_{k} , x ) \}}_{i , j = 1}^{m}$$

These formulae are constructed specifically so that the branching method will provably converge to the optimal filter as the number of particles is increased. For additive zero mean, σ² variance Gaussian noise such as the Kalman filter requires, the formula for ζₖ becomes

$${ζ}_{k} ( x ) = \frac{exp \{ {h}_{k} ( x ) \cdot {Y}_{k}}{{σ}^{2}} - 2 {σ}^{2} {‖ {h}_{k} ( x ) ‖}^{2} \} - 1$$

Similarly to incompletely understood signal dynamics, the model of the noise which is used to form θₖ and gₖ(Yₖ, x) can be approximate if no better knowledge is available.

A uniform-(0,1) random variable U is generated for the particle to be branched, and a comparison is then made between this U and ξₖ(x). U>=|ξₖ(x)| then the particle is not affected by the branching. This is common, especially (because of the form of the calculation of ξₖ(x)) with more difficult types of noise that most reduce the information contained in an observation.

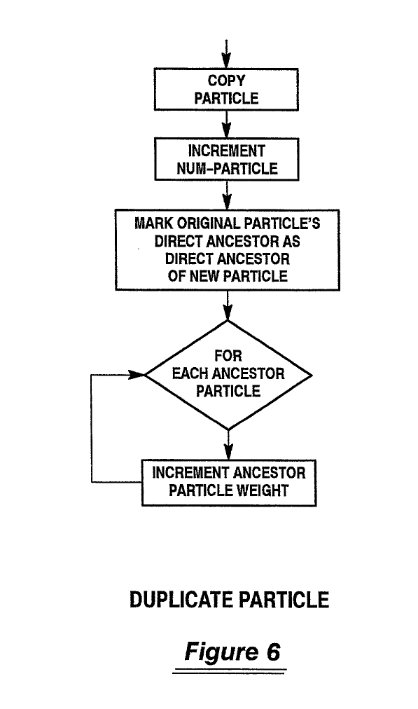

If U<|ξₖ(x)| then, in the case that ξₖ(x)>0, the particle is duplicated (FIG. 6: Duplicate Particle), and in the case that ξₖ(x)<0 the particle is removed (FIG. 7: Remove Particle).

To re-normalize the total particle count (FIG. 5: Re-normalize Particle Count), a value l is set to equal the difference between the current number of particles and the original number. If the current number of particles is greater than the original number, then l of those particles are selected at random to be removed (FIG. 7: Remove Particle). If the current number of particles is less than the original number, then if this number is less than half of the original number of particles, all particles are duplicated (FIG. 6: Duplicate Particle), updating the value of l each time, until the current number of particles is within half of the original number, and then l of the particles are selected at random to be duplicated again. At the end of either possibility the current total number of particles is equal to the original number.

Duplicating a particle (FIG. 6: Duplicate Particle) is performed by first copying the particle state to a separate logical location in the device. The count of the number of particles is then incremented, the new particle is marked as having the same direct ancestor as the original, and the weight value of all ancestor particles (chaining back recursively to include the marked ancestors of ancestor particles) is incremented by one.

To remove a particle (FIG. 7: Remove Particle), first delete the particle state data and decrement the count of the number of particles. Then decrement the weight of all ancestors (chaining back recursively as described above) of the deleted particle, and if the weight of any of these ancestors is reduced to zero, then delete that ancestor particle.

As is the case for any particle filter, the particle locations provide the information to construct the approximated conditional distribution of the signal state. For the optimal tracking filter, the current particles are used with weight value of one for each. To construct an optimal predicting filter, evolve a copy of the current particles forward to the time for which the prediction is to occur, and use a weight value of one for each.

This new branching particle method also allows the construction of optimal smoothing filters. The purpose of the ancestor particles is to retain probabilistic data about the likely historical path of the signal. To use these particles to form a smoothing filter for τₛ<tₖ, select the set of ancestor particles that were created at time tₖ_{ₛ}, where to: tₖ_{ₛ}<=τₛ but is the most recent observation time for which this is true. Copy each of these ancestor particles and evolve them forward to the time τₛ, if τₛ≠tₖ_{ₛ}. Then these particles, weighted by their associated ancestor particle weights, provide the approximate conditional distribution of the signal state at time τₛ. If it is known in advance for which times smoothing filters will be required, then the state of each particle at that time in its evolution can be stored as ancestor particles as well, and no forward evolution will be required during the construction of a smoothing filter. The weight for each of these intermediate ancestor particles will be the same as that of their direct ancestor. Ancestor particle data older than a certain amount of time can be discarded in order to bound the resource usage without disrupting estimates within the remaining period.

The branching particle filter operates recursively on the observation data, allowing real-time operation of the system. It is asymptotically optimal in increasing numbers of particles and in a decreasing period of time between observations, but the rate of convergence with regards to the observation period is extremely fast, so that the difference between the approximation and the optimal filter for practical observation periods is essentially dependent on the number of particles. The particle data can easily be distributed among multiple hardware systems such that operations are efficiently computed in parallel, allowing large numbers of particles to be used practically. In a distributed system, re-normalization of the particle count can be conducted among each of the hardware units separately, or a more complicated scheme including particle transfer among hardware units can be implemented if data transfer within the system is rapid.

A major improvement of our branching particle filter over other methods is the cautious branching, by which is meant the high probability that particle branching will not affect a particle rather than duplicating or removing it. This aspect of the method allows a considerable increase in the speed of the filter, which can be traded for an increase in the number of particles within the same amount of processing power, and thus a closer approximation to the optimal filter. Even at the same particle count as other particle filters, the branching particle filter evinces superior performance in high observation noise cases since there is a smaller variance induced by particle re-distributions. This means that there is a smaller probability that the particles will be redistributed to erroneous locations. For example, the particles may be less likely to redistribute themselves to a single or a few selected previous particle sites in a too focused manner and erroneously attribute too great a commitment to an incorrect determination of the signal state. These advantages are more apparent as the observations become more rapid or as the observation noise becomes more extensive, both of which are situations that increase the practical difficulty of the filtering problem and for which good solutions are most useful, since in these cases the particles are even less likely to be affected during a branch. In situations of extreme observation rate and noise distortion, it is possible with some noise models to approximate and shorten the calculation of the ˜k value without disrupting the asymptotic optimality of the filter, and thereby to decrease the calculation time for each particle further.

The cautious branching is not merely an alternate, faster, and more accurate method for approximating the optimal filter; it is a device which allows the storage of information required to provide optimal smoothers and full historical path filtering by ensuring that past state information is properly associated with each particle. The method of U.S. Pat. No. 5,933,352 and other particle filters destroys this information by redistributing particles to one of a randomly selected set of states at each observation period, disregarding the path that the particle took in the state space to arrive at this new location. The availability of this full historical path data allows the system to provide an even larger set of information than just optimal smoothers. For example, the particle system can be queried to determine the probability that the signal moved from one location to another through a particular path at a particular time. This is a major advancement in the capabilities of practical, general purpose nonlinear filters.

We claim:

1. A real time method for estimating of the conditional probability distribution for the current and future state of a non-linear random dynamic signal process, the method comprising:
providing measurement sensing of sampled data associated with then state of said signal process at sampled instant of time t under consideration,
creating state data for particles that probabilistically resemble the state of said signal process,
calculating branching values for each of said particles of state data at each new instant of time, sampled data is provided by said sensors,
selectively duplicating the state data of said particles' data in accordance with branching value criteria,
selectively deleting the state data of particles of said sampled data in accordance with branching value criteria, and
undertaking in accordance with said branching value calculations, the following actions:
scaling said branching values with measurement noise so as to reduce the duplications and deletions of state data as the effect of the measurement noise increases,
dividing the collection of said particle state data by the number of particles to provide the estimate of a conditional probability distribution of said signal process at the time of the most recent measurement preceding a request for said distribution and probability.
repeatedly computing estimates of said conditional probability distribution based upon the arrival of new sampled data at subsequent sampled instants of time t+n.

2. A method as claimed in claim 1, wherein said method further comprises: estimating the joint conditional probability that said signal process will be represented by any set of possible paths at various past and current instants of time, and by employing sampled data obtained up to the current time to estimate probabilistically said particle paths, by assigning the weight of one divided by the current number of paths to each of said paths.

3. A method as claimed in claim 2, wherein the number of particles are re-normalized by selecting a random set of particle state data to either duplicate, or delete particles of said state data.

5. A method as claimed in claim 1, wherein said method further comprises: storing state data for particle paths through use of ancestor particle state data where an ancestor particle represents a previous particle state and can be an ancestor to more than one particle due to branching,
associating state data with ancestor sampled data to store integer weight values for said ancestral sampled data, which are related to a given ancestral particle, wherein the integer weight represents the number of non-ancestral particles, which are related to said given ancestral particles.
incrementing or decrementing the integer weight for the state data of ancestor particles of sampled data, in accordance with the number of related non-ancestral particles, and
deleting any ancestor particle of sampled data which has a weight of zero.

6. A method as claimed in claim 5, wherein intermediate ancestor state data are generated at specific selected instances of time in order to facilitate the calculation of asymptotically optimal smoothing filters.

7. A method as claimed in claim 6, wherein ancestor state data are discarded when the most recent measurement time is greater than a defined span of time from the creation of said given ancestor particle.

8. A method as claimed in claim 7, wherein intermediate ancestor state data are generated at specific selected instances of time in order to facilitate the calculation of asymptotically optimal smoothing filters.
